(19) United States
(12) Patent Application Publication
(10) Pub. No.: US 2026/0296437 A1
(43) Pub. Date: Oct. 1, 2026

(54) ROAD RECOGNITION DEVICE

(71) Applicant: HONDA MOTOR CO., LTD., Tokyo (JP)

(72) Inventors: Takahiro FUJITA, Tokyo (JP); Ryo Ushiki, Tokyo (JP); Yuki Kizumi, Tokyo (JP)

(73) Assignee: HONDA MOTOR CO., LTD., Tokyo (JP)

(21) Appl. No.: 19/575,959

(22) Filed: Mar. 24, 2026

(30) Foreign Application Priority Data
Mar. 28, 2025 (JP) 2025-055952

(51) Int. Cl. B60W 30/18

(52) U.S. Cl. CPC B60W 30/18159; B60W 2552/10; B60W 2552/15; B60W 2552/53; B60W 2554/4041

(57) ABSTRACT

A road recognition device includes processing circuitry configured to: recognize, at an intersection present in front of a vehicle, a second road present on one side in a vehicle and a third road on a side opposite to the second road across the intersection; recognize an enterable area present; and derive a predetermined reference point based on the results. The processing circuitry is configured to derive a closer reference point of the second road based on a portion belonging to a closer side of a second-road-side enterable area present in the enterable area on a side closer to the second road with respect to the first road, and a farther reference point of the third road based on a portion belonging to a farther side of a third-road-side enterable area present in the enterable area on a side closer to the third road with respect to the first road.

This application is based upon and claims the benefit of priority from prior Japanese patent application No. 2025-55952, filed on Mar. 28, 2025, the entire contents of which are incorporated herein by reference.

### TECHNICAL FIELD

The present disclosure relates to a road recognition device.

### BACKGROUND ART

In recent years, active efforts have been made to provide access to a sustainable transportation system in consideration of vulnerable traffic participants. As one of these efforts, research and development on driving assist techniques and automated driving techniques for moving objects such as automobiles have been made in order to further improve safety and convenience of traffic.

As an example of the driving assist technique, JP2023-160381A discloses a technique of: acquiring intersection information that is information related to an intersection that a host vehicle is about to enter; based on the intersection information, acquiring data indicating a position and direction of each of a plurality of arrow markings in front of the intersection; calculating a distance in a lane width direction to each of the plurality of road arrow markings from a travel track of a vehicle traveling through the intersection; determining a destination of a travel track of the host vehicle based on a direction of a reference road arrow marking that is one of the road arrow markings whose distance is less than a first threshold; generating data indicating a duplicated travel track obtained by duplicating the travel track to be translated to a position of a road arrow marking that indicates the same direction as the destination of the travel track and is different from the reference road arrow marking; and estimating a shape of a traveling lane in the intersection based on the data indicating the duplicated travel track.

### SUMMARY OF INVENTION

There is a demand for obtaining a point (for example, coordinates) corresponding to a corner of an intersection for a vehicle to appropriately travel in the intersection, without requiring high-accuracy map information (also referred to as an “HD (high definition) map”). However, in the related art, there is room for improvement in accurately obtaining a point corresponding to a corner of an intersection without using high-accuracy map information.

Aspects of the present disclosure relate to a road recognition device capable of accurately obtaining a point corresponding to a corner of an intersection without using high-accuracy map information.

According to an aspect of the present disclosure, there is provided a road recognition device including processing circuitry configured to:
perform road recognition to recognize, at an intersection present in front of a vehicle, a second road present on one side in a vehicle width direction with respect to a first road on which the vehicle is currently traveling and a third road extending on a side opposite to the second road across the intersection;
perform enterable area recognition to recognize an enterable area present around the vehicle; and
derive a predetermined reference point based on a result of the road recognition and a result of the enterable area recognition, in which
the processing circuitry is configured to derive, as the reference point, at least one of
   a closer reference point of the second road based on a second-road-side enterable area present in the enterable area on a side closer to the second road with respect to the first road, and
   a farther reference point of the third road based on a third-road-side enterable area present in the enterable area on a side closer to the third road with respect to the first road,
      in a case where the closer reference point is to be derived and in a case where the second-road-side enterable area is continuous in a width direction of the second road, the processing circuitry is configured to perform a partition process by partitioning the second-road-side enterable area into a portion belonging to a closer side and a portion belonging to a farther side when viewed from the vehicle, and derives the closer reference point based on the portion belonging to the closer side partitioned by the partition process, and
      in a case where the farther reference point is to be derived and in case where the third-road-side enterable area is continuous in a width direction of the third road, the processing circuitry is configured to perform the partition process by partitioning the third-road-side enterable area into a portion belonging to a closer side and a portion belonging to a farther side when viewed from the vehicle, and derives the farther reference point based on the portion belonging to the farther side partitioned by the partition process.

According to an aspect of the present disclosure a road recognition device capable of accurately obtaining a point corresponding to a corner of an intersection without using high-accuracy map information may be provided. In addition, it may be possible to improve traffic safety and contribute to the development of the sustainable transportation system.

### BRIEF DESCRIPTION OF DRAWINGS

Exemplary embodiment(s) of the present invention will be described in detail based on the following figures, wherein:

FIG. 1 is a block diagram illustrating a schematic configuration of a vehicle 1 including a control device 30 that is an embodiment of a road recognition device of the present disclosure;

FIG. 2 is a diagram illustrating an example of a situation assumed in the present embodiment;

FIG. 3 is a diagram illustrating an example of a travel trajectory generated when the vehicle 1 is to turn right at an intersection IS;

FIG. 4 is a diagram illustrating an example of a travel trajectory generated when the vehicle 1 is to turn left at the intersection IS;

FIG. 5 illustrates an example of an outline of a partition process;

FIG. 6 illustrates an example of a method for deriving a farther reference point Rp2;

FIG. 7 is a diagram illustrating an example of a method for deriving a closer reference point Rp1;

FIG. 8 is a flowchart (part 1) illustrating the example of the processing procedure by the control device 30;

FIG. 9 is a flowchart (part 2) illustrating the example of the processing procedure by the control device 30;

FIG. 10 is a flowchart (part 3) illustrating the example of the processing procedure by the control device 30;

FIG. 11 is a flowchart (part 4) illustrating the example of the processing procedure by the control device 30;

FIG. 12 is a flowchart (part 5) illustrating the example of the processing procedure by the control device 30;

FIG. 13 is a diagram illustrating a first modification of processing performed by the control device 30; and

FIG. 14 is a diagram illustrating a second modification of the processing performed by the control device 30.

### DESCRIPTION OF EMBODIMENTS

Hereinafter, an embodiment of a road recognition device according to the present disclosure will be described with reference to the drawings. The drawings are viewed in directions of reference signs. The following embodiment does not limit the present disclosure, and not all of elements described in the following embodiment are necessary to the present disclosure. Further, two or more elements described in the following embodiment may be freely combined without departing from the gist of the present disclosure. In the following description, the same or similar elements are denoted by the same or similar reference signs, and a description thereof may be omitted or simplified.

In the present description and the like, in order to simplify and clarify the description, front-rear (including closer and farther), left-right, and upper-lower directions are described according to directions seen from a driver who is an occupant of a vehicle (a vehicle 1 to be described later), and in the drawings, a front side of the vehicle is denoted by Fr, a rear side is denoted by Rr, a left side is denoted by L, and a right side is denoted by R.

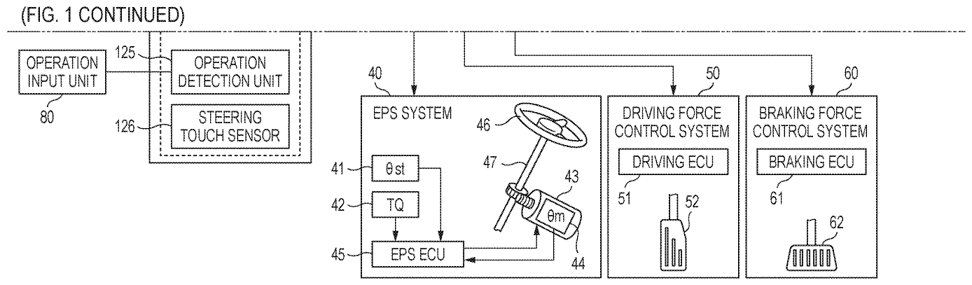

Further, the following embodiment will assume a left-hand traffic region such as Japan and describe an example in which one side in the vehicle width direction in the present disclosure is set to the left side and the other side in the vehicle width direction is set to the right side, but is not limited thereto. For example, when the present disclosure is applied to a right-hand traffic region such as the United States of America or the People's Republic of China, the one side in the vehicle width direction in the present disclosure may be set to the right side, and the other side in the vehicle width direction may be set to the left side. In this case, “right” and “left” in the following description may be interpreted as “left” and “right”, respectively, and FIGS. 2 to 4 and the like may be viewed with the left and right reversed as necessary.

### 1. VEHICLE

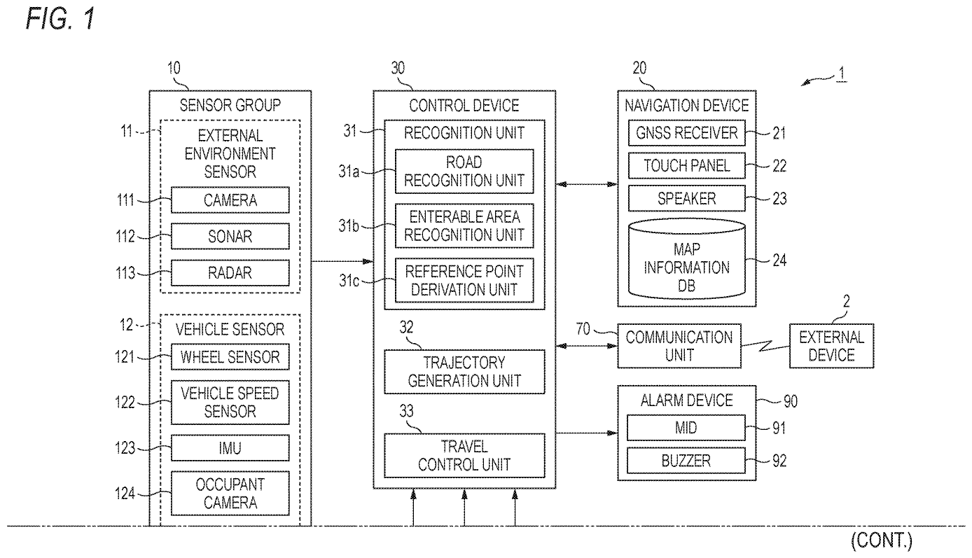

FIG. 1 is a block diagram illustrating a schematic configuration of a vehicle 1 including a control device 30 that is an embodiment of a road recognition device of the present disclosure. The vehicle 1 according to the present embodiment illustrated in FIG. 1 is an automobile including a drive source (not illustrated), and wheels (not illustrated) including drive wheels driven by power of the drive source and steered wheels that are steerable. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 includes a sensor group 10, a navigation device 20, a control device 30 that is an example of the road recognition device of the present disclosure, an electric power steering (EPS) system 40, a driving force control system 50, a braking force control system 60, a communication unit 70, an operation input unit 80, and an alarm device 90.

The sensor group 10 includes an external environment sensor 11 that acquires information on surroundings of the vehicle 1 (hereinafter also referred to as “external information”), and a vehicle sensor 12 that acquires information on the vehicle 1 (hereinafter also referred to as “vehicle information”). Information (in other words, detection values) acquired by each sensor in the sensor group 10 is output to the control device 30, and is used for control of the vehicle 1 (hereinafter, also referred to as “vehicle control”) performed by the control device 30.

The external environment sensor 11 includes, for example, cameras 111, a sonar 112, and a radar 113. The camera 111 is an imaging device that images the surroundings of the vehicle 1 including a front side of the vehicle 1 and outputs image data of the obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to the surroundings of the vehicle 1 (for example, the front side, a rear side, and lateral sides of the vehicle 1), and receives reflected sounds from an object present in the surroundings of the vehicle 1, thereby detecting a distance to the object, a direction of the object, and the like. The radar 113 emits radio waves to the surroundings of the vehicle 1 including the front side of the vehicle 1, and receives reflected waves from an object present in the surroundings of the vehicle 1, thereby detecting a distance to the object, a direction of the object, and the like. The radar 113 may be, for example, a millimeter wave radar.

The external environment sensor 11 may include light detection and ranging (LiDAR) instead of or in addition to the sonar 112 and the radar 113. In this case, the LiDAR emits laser light to the surroundings of the vehicle 1 including the front side of the vehicle 1, and receives reflected light from an object present in the surroundings of the vehicle 1, thereby detecting a distance to the object, a direction of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of the left rear wheel and the right rear wheel. The wheel sensor 121 may be, for example, an angle sensor or a displacement sensor.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not illustrated) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called “driver monitor camera” that is provided to be able to image a head of an occupant (hereinafter, referred to as a “driver”) sitting in a driver seat of the vehicle 1 from the front (in other words, be able to image a face). Similar to the camera 111, the occupant camera 124 may be a digital camera using an imaging element such as a CCD or a CMOS.

The operation detection unit 125 detects an operation performed by using the operation input unit 80 that is operable by the driver. In the present embodiment, the operation input unit 80 can include, for example, an operation button for receiving an operation to switch between on (in other words, operation) and off (in other words, non-operation) of predetermined driving assist control such as steering control performed by a travel control unit 33 to be described later. In this case, the operation detection unit 125 can detect an operation of turning on or off the predetermined driving assist control.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the driver when the steering 46 is gripped appropriately.

The navigation device 20 includes, for example, a global navigation satellite system (GNSS) receiver 21, a touch panel 22, and a speaker 23. The navigation device 20 includes a storage unit (not illustrated) implemented by a flash memory or the like. The storage unit of the navigation device 20 stores a map information database (DB) 24 as an example of map information and the like.

The map information database 24 includes road network information. The road network information is information representing roads based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a traveling direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire the detection result of the vehicle sensor 12 (for example, the wheel sensor 121 or the vehicle speed sensor 122) via the control device 30, and specify or complement the current position of the vehicle 1 by an inertial navigation system (INS) using the detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output sound to the occupant (for example, the driver) of the vehicle 1.

For example, the navigation device 20 searches for, by referring to the map information database 24, a route from the current position of the vehicle 1 to a destination set by the driver using the touch panel 22. Then, the navigation device 20 performs route guidance using the touch panel 22 and the speaker 23 based on the route searched for. Further, the navigation device 20 may cause the touch panel 22 to perform a predetermined display according to an instruction from the control device 30. Further, the navigation device 20 may output, to the control device 30, information indicating the specified current position of the vehicle 1 or predetermined information (for example, information indicating an operation received via the touch panel 22).

In the present embodiment, the control device 30 is configured to refer to the map information database 24 (that is, map information) of the navigation device 20. However, the present disclosure is not limited thereto, the map information including the road network information similar to that of the map information database 24 may be separately stored in the control device 30 or the like, and the control device 30 may refer to such map information.

The control device 30 is a computer that includes, for example, processing circuitry such as a processor configured to perform various calculations, a storage unit having a non-transitory storage medium (for example, a flash memory) for storing various types of information, and an input and output unit configured to control input and output of data between the inside and the outside of the control device 30 (none is illustrated), and executes overall control of the vehicle 1. For example, the control device 30 is implemented by one electronic control unit (ECU) or by a plurality of ECUs working in cooperation with each other. Since specific examples of control executed by the control device 30 will be described later, the description thereof will be omitted here.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the driver in operating the steering 46 by applying, according to an instruction from the EPS ECU 45, a driving force or a reaction force to a steering column 47 connected to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is illustrated), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, processing circuitry like a processor configured to perform various calculations, a storage unit having a non-transitory storage medium for storing various types of information, and an input and output unit configured to control input and output of data between the inside and the outside of the driving ECU 51 (none is illustrated), and controls the driving force control system 50. The driving ECU 51 is implemented by one or more ECUs. For example, based on an operation on an accelerator pedal 52 provided in the vehicle 1, the driving ECU 51 controls the power output from the drive source of the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor configured to perform various calculations, a storage unit having a non-transitory storage medium for storing various types of information, and an input and output unit configured to control input and output of data between the inside and the outside of the braking ECU 61 (none is illustrated), and controls the braking force control system 60. The braking ECU 61 is implemented by one or more ECUs. For example, the braking ECU 61 controls the braking force of the vehicle 1 by controlling a brake device (not illustrated) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under the control of the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be used for communication between the vehicle 1 and the external device 2.

The alarm device 90 is a device that alarms the driver under control of the control device 30. The alarm device 90 includes, for example, a multi-information display (MID) 91 and a buzzer 92.

The MID 91 is implemented by a display device such as a liquid crystal display or an OLED, and is provided at a position that the driver can visually recognize (for example, in a meter panel of the vehicle 1). For example, the MID 91 displays a predetermined alarm image according to an instruction from the control device 30. The MID 91 may be integrated with the touch panel 22 described above. That is, the “MID 91” in the following description may be interpreted as the “touch panel 22”.

The buzzer 92 is configured to output a predetermined alarm sound. For example, the buzzer 92 outputs a predetermined alarm sound according to an instruction from the control device 30. The buzzer 92 may be integrated with the speaker 23 described above. That is, the “buzzer 92” in the following description may be interpreted as the “speaker 23”.

### 2. CONTROL DEVICE

Next, the control device 30 will be described in more details. First, in order to simplify and clarify the following description, terms that may be used in the following description will be described.

FIG. 2 is a diagram illustrating an example of a situation assumed in the present embodiment. The present embodiment assumes that, for example, the vehicle 1 travels at an intersection IS of a four-way intersection as illustrated in FIG. 2.

### Travel Road Rd1

In FIG. 2, a travel road Rd1 is a road on which the vehicle 1 currently travels, and is a two-lane road including a lane Ln11 and a lane Ln12. The travel road Rd1 is an example of a first road in the present disclosure.

The lane Ln11 is a lane whose traveling direction is a direction from the lower side toward the upper side in FIG. 2, and can also be referred to as the “host lane” in which the vehicle 1 travels. The lane Ln12 is a lane whose traveling direction is a direction from the upper side toward the lower side in FIG. 2, and can also be referred to as an “oncoming lane” whose traveling direction is opposite to that of the host lane.

A road boundary RB11 is a boundary between the travel road Rd1 and the outside on the left side of the travel road Rd1. A road boundary RB12 is a boundary between the travel road Rd1 and the outside on the right side of the travel road Rd1.

A road division line Ml11 is a division line or the like that defines the lane Ln11 from the outside on the left side thereof, and is specifically a division line or a curb provided along the road boundary RB11. An extension line Ml11a is an extension line of the road division line Ml11, and is specifically a virtual line extending the road division line Ml11 to the farther side (in other words, toward the intersection IS).

A road division line Ml12 is a division line or the like that defines the lane Ln12 from the outside on the right side thereof, and is specifically a division line or a curb provided along the road boundary RB12. An extension line Ml12a is an extension line of the road division line Ml12, and is specifically a virtual line extending the road division line Ml12 to the farther side (in other words, toward the intersection IS).

### Left Road Rd2

The left road Rd2 is a road present on the left side (that is, one side in the vehicle width direction) from the travel road Rd1, and is a two-lane road including a lane Ln21 and a lane Ln22. The left road Rd2 is an example of a second road in the present disclosure.

The lane Ln21 is a lane whose traveling direction is a direction from the right toward the left in FIG. 2. The lane Ln22 is a lane whose traveling direction is a direction from the left toward the right in FIG. 2.

A road boundary RB21 is a boundary between the left road Rd2 and the outside on the closer side of the left road Rd2. A road boundary RB22 is a boundary between the left road Rd2 and the outside on the farther side of the left road Rd2.

A road division line Ml21 is a division line or the like that defines the lane Ln21 from the outside on the closer side thereof, and is specifically a division line or a curb provided along the road boundary RB21. An extension line Ml21a is an extension line of the road division line Ml21, and is specifically a virtual line extending the road division line Ml21 to the right side (in other words, toward the intersection IS). A cross point CP1 is an intersection between the extension line Ml21a and the extension line Ml11a described above.

A road division line Ml22 is a division line or the like that defines the lane Ln22 from the outside on the farther side thereof, and is specifically a division line or a curb provided along the road boundary RB22. An extension line Ml22a is an extension line of the road division line Ml22, and is specifically a virtual line extending the road division line Ml22 to the right side (in other words, toward the intersection IS).

### Right Road Rd3

A right road Rd3 is a road extending on the side opposite to the left road Rd2 across the intersection IS, that is, a road present on the right side (that is, the other side in the vehicle width direction) of travel road Rd1, and is a two-lane road including a lane Ln31 and a lane Ln32. The right road Rd3 is an example of a third road in the present disclosure.

The lane Ln31 is a lane whose traveling direction is a direction from the left toward the right in FIG. 2. The lane Ln32 is a lane whose traveling direction is a direction from the right toward the left in FIG. 2.

A road boundary RB31 is a boundary between the right road Rd3 and the outside on the farther side of the right road Rd3. A road boundary RB32 is a boundary between the right road Rd3 and the outside on the closer side of the right road Rd3.

A road division line Ml31 is a division line or the like that defines the lane Ln31 from the outside on the farther side thereof, and is specifically a division line or a curb provided along the road boundary RB31. An extension line Ml31a is an extension line of the road division line Ml31, and is specifically a virtual line extending the road division line Ml31 to the left side (in other words, toward the intersection IS).

A road division line Ml32 is a division line or the like that defines the lane Ln32 from the outside on the closer side thereof, and is specifically a division line or a curb provided along the road boundary RB32. An extension line Ml32a is an extension line of the road division line Ml32, and is specifically a virtual line extending the road division line Ml32 to the left side (in other words, toward the intersection IS).

### Opposite Road Rd4

The opposite road Rd4 is a road extending on the side opposite to the travel road Rd1 across the intersection IS, and is a two-lane road including a lane Ln41 and a lane Ln42. The opposite road Rd4 is an example of a fourth road in the present disclosure.

The lane Ln41 is a lane whose traveling direction is a direction from the lower side toward the upper side in FIG. 2. The lane Ln42 is a lane whose traveling direction is a direction from the upper side toward the lower side in FIG. 2.

A road boundary RB41 is a boundary between the opposite road Rd4 and the outside on the left side of the opposite road Rd4. A road boundary RB42 is a boundary between the opposite road Rd4 and the outside on the right side of the opposite road Rd4.

A road division line Ml41 is a division line or the like that defines the lane Ln41 from the outside on the left side thereof, and is specifically a division line or a curb provided along the road boundary RB41. An extension line Ml41a is an extension line of the road division line Ml41, and is specifically a virtual line extending the road division line Ml41 to the closer side (in other words, toward the intersection IS described later). A cross point CP3 is an intersection between the extension line Ml41a and the extension line Ml22a described above.

A road division line Ml42 is a division line or the like that defines the lane Ln42 from the outside on the right side thereof, and is specifically a division line or a curb provided along the road boundary RB42. An extension line Ml42a is an extension line of the road division line Ml42, and is specifically a virtual line extending the road division line Ml42 to the closer side (in other words, toward the intersection IS described later). A cross point CP2 is an intersection between the extension line Ml42a and the extension line Ml31a described above.

### Intersection IS

The intersection IS is a four-way intersection obtained by connecting the travel road Rd1, the left road Rd2, the right road Rd3, and the opposite road Rd4.

### Closer Reference Point Rp1

A closer reference point Rp1 is a point (for example, coordinates) corresponding to the left closer corner of the intersection IS under the control of the control device 30, and can also be referred to as a contact point between the travel road Rd1 and the left road Rd2. For example, if the control device 30 can recognize a connection portion (for example, an arc-shaped portion) Cn1 between the road boundary RB11 of the travel road Rd1 and the road boundary RB21 of the left road Rd2, the closer reference point Rp1 may be a point closest to the cross point CP1 between the extension line Ml11a and the extension line Ml21a at a connection portion Cn1. Further, the control device 30 may derive the closer reference point Rp1 using a left enterable area FS_L described later.

### Farther Reference Point Rp2

A farther reference point Rp2 is a point corresponding to the right farther corner of the intersection IS under the control of the control device 30, and can also be referred to as a contact point between the right road Rd3 and the opposite road Rd4. For example, if the control device 30 can recognize a connection portion (for example, an arc-shaped portion) Cn2 between the road boundary RB31 of the right road Rd3 and the road boundary RB42 of the opposite road Rd4, the farther reference point Rp2 may be a point closest to the cross point CP2 between the extension line Ml31a and the extension line Ml42a at the connection portion Cn2. Further, the control device 30 may derive the farther reference point Rp2 using a right enterable area FS_R described later.

### Boundary Line Bd

A boundary line Bd is a virtual line of a line segment passing through the closer reference point Rp1 and the farther reference point Rp2.

### Enterable Area FS

The enterable area FS is an area that the vehicle 1 can enter and that is recognized based on the external information obtained by the external environment sensor 11 described above. For example, an area where the passage of the vehicle 1 is not obstructed by any object and the passage of the vehicle 1 is legally permitted can be recognized as the enterable area FS. However, the present disclosure is not limited thereto, and for example, the manufacturer of the vehicle 1 or the like can freely determine the area to be set as the enterable area FS.

In the present embodiment, the enterable area FS is represented by a point group (hereinafter, also referred to as a “free space (FS) point group”). That is, the enterable area FS includes a plurality of FS points, and each FS point represents a point (in other words, coordinates of a position) through which the vehicle 1 can pass.

The enterable area FS includes a left enterable area FS_L, which is a portion present in the enterable area FS on a side closer to the left road Rd2 with respect to the travel road Rd1, and a right enterable area FS_R, which is a portion present in the enterable area FS on a side closer to the right road Rd3 with respect to the travel road Rd1. The left enterable area FS_L is an example of a second-road-side enterable area in the present disclosure, and the right enterable area FS_R is an example of a third-road-side enterable area in the present disclosure.

Here, being present in the enterable area FS on the side closer to the left road Rd2 with respect to the travel road Rd1 means, for example, being present on the side closer to the left road Rd2 with respect to the vehicle 1 traveling on the travel road Rd1 (more specifically, a representative point of the vehicle 1). Similarly, being present in the enterable area FS on the side closer to the right road Rd3 with respect to the travel road Rd1 means, for example, being present on the side closer to the right road Rd3 with respect to the vehicle 1 traveling on the travel road Rd1.

For example, the left enterable area FS_L can be a left outer edge of the enterable area FS, and the right enterable area FS_R can be a right outer edge of the enterable area FS. Although details will be described later, in the present embodiment, the left enterable area FS_L can be partitioned into a portion FS_LN belonging to the closer side and a portion FS_LF belonging to the farther side. In other words, the left enterable area FS_L may include the portion FS_LN belonging to the closer side and the portion FS_LF belonging to the farther side. Similarly, the right enterable area FS_R can be partitioned into a portion FS_RN belonging to the closer side and a portion FS_RF belonging to the farther side. In other words, the right enterable area FS_R may include the portion FS_RN belonging to the closer side and the portion FS_RF belonging to the farther side.

### Functional Units of Control Device

The control device 30 includes, for example, a recognition unit 31, a trajectory generation unit 32, and a travel control unit 33 as functional units implemented by the processor executing a program stored in the storage unit of the control device 30.

The recognition unit 31 recognizes a surrounding situation of the vehicle 1. For example, the recognition unit 31 recognizes the surrounding situation of the vehicle 1 based on point group information on the vehicle 1 obtained by performing predetermined sensor fusion processing on detection results obtained by some or all of the camera 111, the sonar 112, and the radar 113 in the external environment sensor 11.

The recognition unit 31 recognizes a position, a type, a speed, an acceleration, and the like of an object present around the vehicle 1 as the surrounding situation of the vehicle 1. At this time, the recognition unit 31 recognizes the position of the object as, for example, a position on an absolute coordinate system in which a predetermined representative point such as the center of gravity or the center of the drive shaft of the vehicle 1 is set as the origin (for example, an absolute coordinate system with the front-rear direction of the vehicle 1 as the x axis and the vehicle width direction of the vehicle 1 as the y axis). In the absolute coordinate system, the position of the object may be represented using a representative point such as a center of gravity or a corner of the object, or may be represented as an area.

Examples of the object that can be recognized by the first recognition unit 31 include road division lines that define lanes such as division lines, curbs and separation zones, road structures such as guard rails and road shoulders, road markings, and road signs. The recognition unit 31 can also recognize, for example, other road events such as traffic lights, stop lines, crosswalks, branches, merging, interchanges, and tollgates of toll roads, and traffic participants such as other vehicles and pedestrians.

In the present embodiment, the recognition unit 31 includes, for example, a road recognition unit 31a, an enterable area recognition unit 31b, and a reference point derivation unit 31c.

The road recognition unit 31a recognizes a road around the vehicle 1. For example, the road recognition unit 31a recognizes a road around the vehicle 1 based on the road division lines, the road structures, and the like recognized by the recognition unit 31. For example, the road recognition unit 31a may recognize the road around the vehicle 1 based on the current position of the vehicle 1 specified by the navigation device 20 (for example, the GNSS receiver 21) and the map information such as the map information database 24.

The road recognition unit 31a can recognize the intersection IS present in front of the vehicle 1 (that is, in the traveling direction), the travel road Rd1, the left road Rd2, the right road Rd3, and the opposite road Rd4 connected to the intersection IS, and the like.

The enterable area recognition unit 31b recognizes the enterable area FS present around the vehicle 1 based on the external information acquired by the external environment sensor 11. For example, as described above, the enterable area recognition unit 31b recognizes, as the enterable area FS, an area where the passage of the vehicle 1 is not obstructed by any object and the passage of the vehicle 1 is legally permitted. The enterable area recognition unit 31b recognizes the FS point group as the enterable area FS.

The reference point derivation unit 31c derives a predetermined reference point such as the closer reference point Rp1 or the farther reference point Rp2 based on the recognition result of the road recognition unit 31a and the recognition result of the enterable area recognition unit 31b.

More specifically, the reference point derivation unit 31c derives, as the reference point, at least one of the closer reference point Rp1 of the left road Rd2 based on the left enterable area FS_L and the farther reference point Rp2 of the right road Rd3 based on the right enterable area FS_R. In the present embodiment, if the vehicle 1 is to turn right at the intersection IS, the reference point derivation unit 31c derives the closer reference point Rp1 and the farther reference point Rp2 to cause the vehicle 1 to travel along the boundary line Bd described above.

If the closer reference point Rp1 is to be derived and if the left enterable area FS_L is continuous in the width direction of the left road Rd2, the reference point derivation unit 31c performs a partition process of partitioning the left enterable area FS_L into the portion FS_LN belonging to the closer side and the portion FS_LF belonging to the farther side when viewed from the vehicle 1. The reference point derivation unit 31c derives the closer reference point Rp1 based on the portion FS_LN belonging to the closer side partitioned by the partition process. Here, the left enterable area FS_L being continuous in the width direction of the left road Rd2 means, for example, that the FS points representing the left enterable area FS_L continuously exist in the width direction of the left road Rd2.

As described above, if the closer reference point Rp1 is to be derived and if the left enterable area FS_L is continuous in the width direction of the left road Rd2, the reference point derivation unit 31c (that is, the control device 30) partitions the left enterable area FS_L into the portion FS_LN belonging to the closer side and the portion FS_LF belonging to the farther side, and derives the closer reference point Rp1 based on the partitioned portion FS_LN belonging to the closer side. Accordingly, even if a left enterable area FS_L that is continuous in the width direction of the left road Rd2 is recognized, it is possible to derive the closer reference point Rp1 with high accuracy with respect to the corner (for example, the left closer corner) of the actual intersection IS.

Alternatively, if the farther reference point Rp2 is to be derived and if the right enterable area FS_R is continuous in the width direction of the right road Rd3, the reference point derivation unit 31c performs a partition process of partitioning the right enterable area FS_R into the portion FS_RN belonging to the closer side and the portion FS_RF belonging to the farther side when viewed from the vehicle 1. The reference point derivation unit 31c derives the farther reference point Rp2 based on the portion FS_RF belonging to the farther side partitioned by the partition process. Here, the right enterable area FS_R being continuous in the width direction of the right road Rd3 means that the FS points representing the right enterable area FS_R continuously exist in the width direction of the right road Rd3.

As described above, if the farther reference point Rp2 is to be derived and if the right enterable area FS_R is continuous in the width direction of the right road Rd3, the reference point derivation unit 31c (that is, the control device 30) partitions the right enterable area FS_R into the portion FS_RN belonging to the closer side and the portion FS_RF belonging to the farther side, and derives the farther reference point Rp2 based on the partitioned portion FS_RF belonging to the farther side. As a result, even if a right enterable area FS_R that is continuous in the width direction of the right road Rd3 is recognized, it is possible to derive the farther reference point Rp2 with high accuracy with respect to the corner (for example, the right farther corner) of the actual intersection IS.

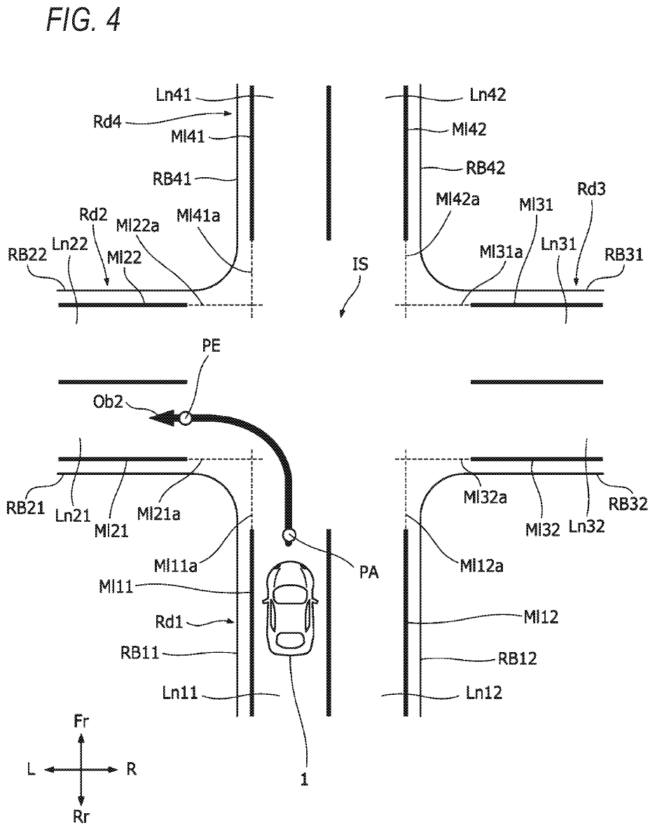

An example of the specific method for deriving the closer reference point Rp1 and the farther reference point Rp2 will be described later with reference to FIGS. 5 to 7 and the like, and thus description thereof will be omitted here.

If the intersection IS present in the traveling direction of the vehicle 1 is recognized by the road recognition unit 31a, the trajectory generation unit 32 generates a travel trajectory from the entry position of the vehicle 1 at the intersection IS (hereinafter, also referred to as an “entry position PA”) to the exit position of the vehicle 1 at the intersection IS (hereinafter, also referred to as an “exit position PE”). Here, the travel trajectory is a trajectory for the vehicle 1 to travel, and can also be referred to as a “target traveling line”.

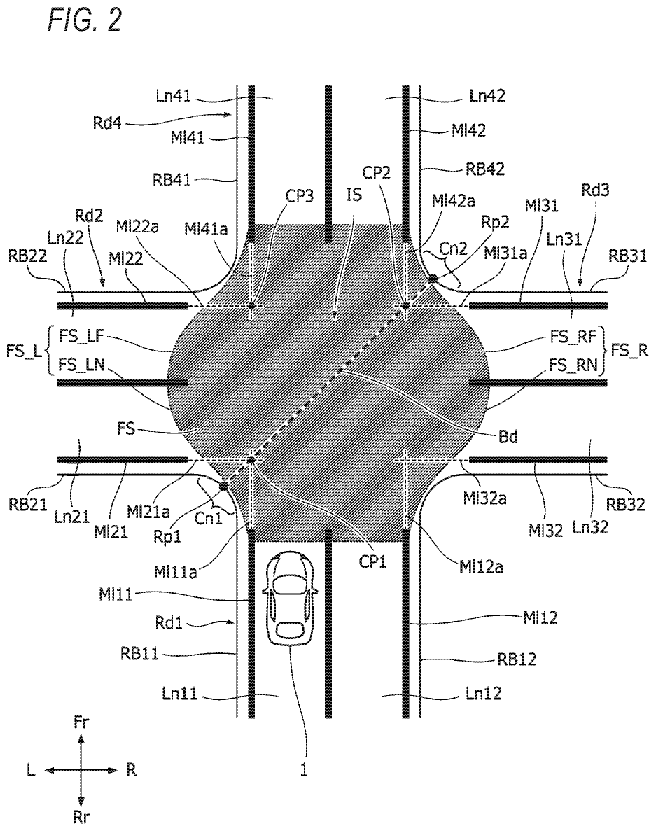

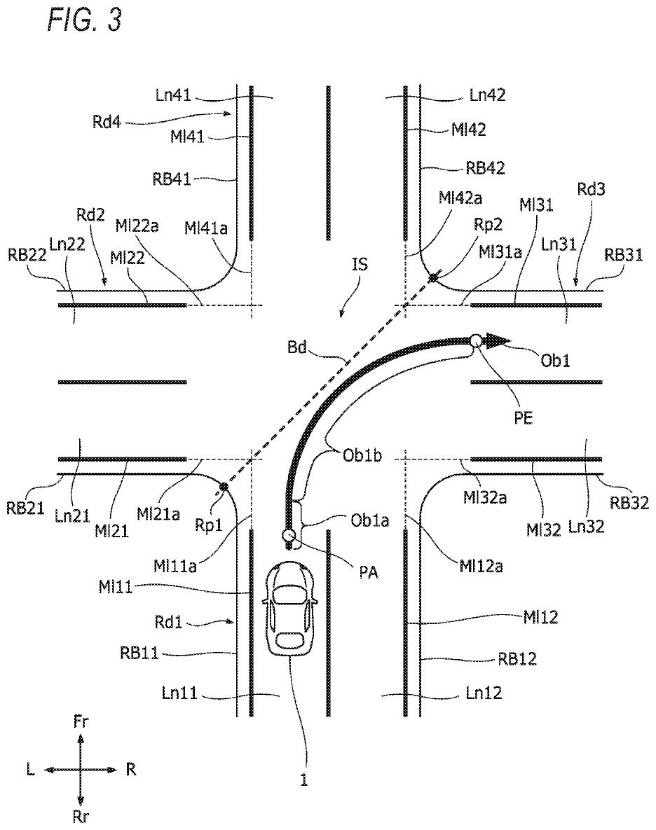

For example, if the vehicle 1 is to travel from the travel road Rd1 toward the right road Rd3 at the intersection IS (in other words, if the vehicle 1 is to turn right at the intersection IS), the trajectory generation unit 32 derives the boundary line Bd, which is a line segment passing through the closer reference point Rp1 and the farther reference point Rp2 described above, and generates a travel trajectory along the boundary line Bd (for example, see a travel trajectory Ob1 in FIG. 3). A specific example of the travel trajectory generated by the trajectory generation unit 32 will be described later with reference to FIGS. 3 and 4.

The road (that is, the direction) the vehicle 1 is about to travel at the intersection IS can be determined based on, for example, route guidance performed by the navigation device 20 or the lighting state of a direction indicator (not illustrated) included in the vehicle 1. If the vehicle 1 is an autonomous vehicle that travels autonomously, the road the vehicle 1 is about to travel at the intersection IS may be determined based on a travel plan generated based on a route to a destination.

The travel control unit 33 causes the vehicle 1 to travel based on the travel trajectory generated by the trajectory generation unit 32. Specifically, the travel control unit 33 may control the steering of the vehicle 1 via the EPS system 40 such that the vehicle 1 travels while tracing the travel trajectory (in other words, the target traveling line) generated by the trajectory generation unit 32. At this time, the travel control unit 33 may control the driving force of the vehicle 1 via the driving force control system 50, or may control the braking force of the vehicle 1 via the braking force control system 60.

### 3. TRAVEL TRAJECTORY GENERATED BY TRAJECTORY GENERATION UNIT

Next, a specific example of the travel trajectory generated by the trajectory generation unit 32 will be described with reference to FIGS. 3 and 4. In the drawings including FIGS. 3 and 4, similarly to the example illustrated in FIG. 2, the vehicle 1 travels on the travel road Rd1 toward the intersection IS, and the intersection IS is present in the traveling direction (that is, in front) of the vehicle 1.

### Travel Trajectory Generated When Vehicle is to Turn Right at Intersection

FIG. 3 is a diagram illustrating an example of a travel trajectory generated when the vehicle 1 is to turn right at the intersection IS. In the example illustrated in FIG. 3, the vehicle 1 is about to turn right at the intersection IS and travel toward the right road Rd3. In this case, the trajectory generation unit 32 derives the boundary line Bd passing through the closer reference point Rp1 and the farther reference point Rp2 derived by the reference point derivation unit 31c, and generates the travel trajectory Ob1 along the boundary line Bd.

As described above, if the vehicle 1 is to turn right at the intersection IS, by deriving the boundary line Bd passing through the closer reference point Rp1 and the farther reference point Rp2 and generating the travel trajectory Ob1 along the boundary line Bd, it is possible to cause the vehicle 1 to travel from the travel road Rd1 toward the right road Rd3 on the appropriate travel trajectory Ob1 in consideration of an oncoming vehicle without requiring high-accuracy map information.

If the vehicle 1 is to turn right at the intersection IS, the trajectory generation unit 32 may generate, for example, a travel trajectory Ob1 including a first trajectory Ob1a that travels straight from the entry position PA to a position in front of the boundary line Bd by a predetermined distance and a second trajectory Ob1b that curves from the end of the first trajectory Ob1a along the boundary line Bd. In this way, it is possible to cause the vehicle 1, which is about to travel from the travel road Rd1 toward the right road Rd3, to travel based on the same travel trajectory Ob1 as the travel trajectory when the occupant of the vehicle 1 drives (that is, the travel trajectory when turning right at the intersection IS by manual driving).

In the present example, the entry position PA may be, for example, a position at the center in the width direction of the lane Ln11 on the right side (that is, the “R” side illustrated in FIG. 3) of the end closer to the intersection IS of the road division line Ml11 of the lane Ln11, which is the host lane. The exit position PE may be, for example, a position at the center in the width direction of the lane Ln31 on the closer side (that is, the “Rr” side illustrated in FIG. 3) of the end closer to the intersection IS of the road division line Ml31 of the lane Ln31, which is the destination of right turn.

### Travel Trajectory Generated When Vehicle is to Turn Left at Intersection

FIG. 4 is a diagram illustrating an example of the travel trajectory generated when the vehicle 1 is to turn left at the intersection IS. In the example illustrated in FIG. 4, the vehicle 1 is about to turn left at the intersection IS and travel toward the left road Rd2. In this case, the trajectory generation unit 32 generates a travel trajectory Ob2 from the entry position PA toward the exit position PE along the road division line Ml11 on the left side of the travel road Rd1 and the extension line Ml11a thereof based on the recognition result of the recognition unit 31 (for example, the road recognition unit 31a).

In the present example, the entry position PA may be, for example, a position at the center in the width direction of the lane Ln11 on the right side (that is, the “R” side illustrated in FIG. 4) of the end closer to the intersection IS of the road division line Ml11 of the lane Ln11, which is the host lane. The exit position PE may be, for example, a position at the center in the width direction of the lane Ln21 on the front side (that is, the “Fr” side illustrated in FIG. 4) of the end closer to the intersection IS of the road division line Ml21 of the lane Ln21, which is the destination of left turn.

If the vehicle 1 is to turn left at the intersection IS and the vehicle 1 has already entered the intersection IS, the trajectory generation unit 32 may generate the travel trajectory Ob2 from the current position of the vehicle 1 toward the exit position PE (in other words, from the current position of the vehicle 1 toward the entrance of the lane Ln21) based on the recognition result of the recognition unit 31.

As described above, if the vehicle 1 is to turn left at the intersection IS, by generating the travel trajectory Ob2 along the road division line Ml11 on the left side of the travel road Rd1 based on the recognition result of the recognition unit 31, it is possible to cause the vehicle 1 to travel from the travel road Rd1 toward the left road Rd2 along the appropriate travel trajectory Ob2 without turning too sharply or too gently at the intersection IS, without requiring high-accuracy map information.

Although illustration and detailed description are omitted, if the vehicle 1 is to travel straight at the intersection IS, the trajectory generation unit 32 may generate, for example, a travel trajectory along which the vehicle 1 travels from the exit of the travel road Rd1 toward the entrance of the opposite road Rd4 without interfering with the center of the intersection IS. Here, the center of the intersection IS may be, for example, the intersection of a first line segment (for example, the boundary line Bd) connecting the left closer corner (for example, the closer reference point Rp1) and the right farther corner (for example, the farther reference point Rp2) of the intersection IS and a second line segment connecting the right closer corner and the left farther corner of the intersection IS. Alternatively, the center of the intersection IS may be, for example, a point where a predetermined road marking indicating the center of the intersection IS is present.

### 4. PARTITION PROCESS PERFORMED BY REFERENCE POINT DERIVATION UNIT

Next, an outline of the partition process performed by the reference point derivation unit 31c will be described with reference to FIG. 5. For example, if the end of the right road Rd3 cannot be seen from the vehicle 1, the right enterable area FS_R of the enterable area FS recognized by the enterable area recognition unit 31b can be continuous in the width direction of the right road Rd3 as illustrated in FIG. 5. The right enterable area FS_R continuous in the width direction of the right road Rd3 has, for example, a mountain-like shape protruding toward the end of the right road Rd3 (in other words, the side opposite to the intersection IS).

If the farther reference point Rp2 is to be derived and if the right enterable area FS_R is continuous in the width direction of the right road Rd3, the reference point derivation unit 31c performs a partition process of partitioning the right enterable area FS_R into the portion FS_RN belonging to the closer side and the portion FS_RF belonging to the farther side when viewed from the vehicle 1.

As described above, the right enterable area FS_R being continuous in the width direction of the right road Rd3 means, for example, that the FS points representing the right enterable area FS_R continuously exist in the width direction of the right road Rd3. More specifically, this means that a separation distance d between FS points adjacent in the width direction of the right road Rd3 is equal to or less than a predetermined value. In the example illustrated in FIG. 5, the separation distance d between the FS points adjacent to each other in the width direction of the right road Rd3, such as a separation distance d_ij between an FS point Pi and an FS point Pj included in the right enterable area FS_R and a separation distance d_jk between an FS point Pj and an FS point Pk, is equal to or less than a predetermined value.

As illustrated in FIG. 5, if the right enterable area FS_R has a mountain-like shape, the reference point derivation unit 31c may partition the right enterable area FS_R into the portion FS_RN belonging to the closer side and the portion FS_RF belonging to the farther side based on a top position Tp of a mountain represented by the right enterable area FS_R.

In this way, if the right enterable area FS_R has a mountain-like shape, by partitioning the right enterable area FS_R into the portion FS_RN belonging to the closer side and the portion FS_RF belonging to the farther side based on the top position Tp of the mountain, it is possible to partition the right enterable area FS_R into the portion FS_RN belonging to the closer side and the portion FS_RF belonging to the farther side by simple processing.

As another example, the reference point derivation unit 31c may perform fitting on the right enterable area FS_R using an approximate curve CA that is a virtual line having a predetermined shape, and may partition the right enterable area FS_R into the portion FS_RN belonging to the closer side and the portion FS_RF belonging to the farther side based on a top position Tc of the approximate curve CA after fitting.

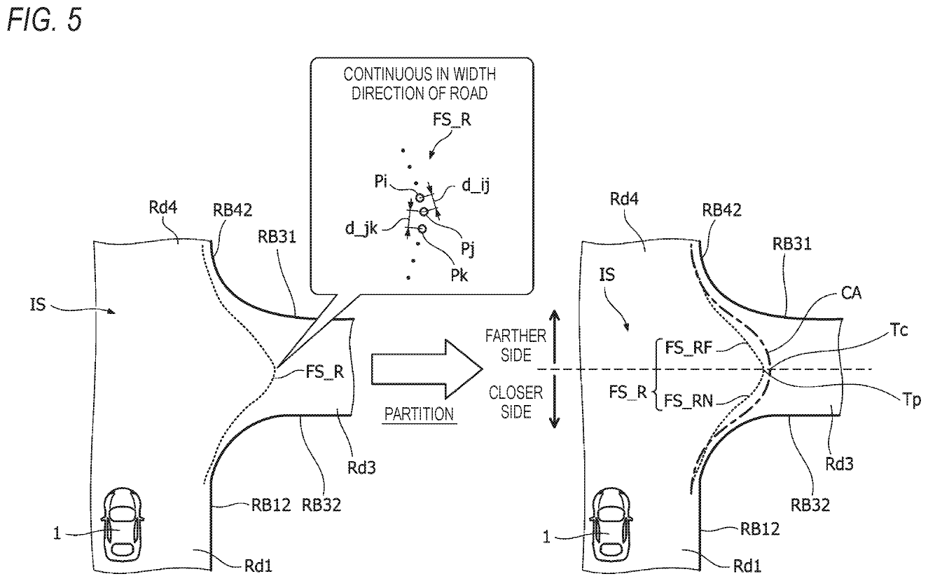

In this way, by fitting the right enterable area FS_R with the approximate curve CA which is a virtual line having a predetermined shape and partitioning the right enterable area FS_R into the portion FS_RN belonging to the closer side and the portion FS_RF belonging to the farther side based on the top position Tc of the approximate curve CA after fitting, it is possible to partition the right enterable area FS_R into the portion FS_RN belonging to the closer side and the portion FS_RF belonging to the farther side regardless of the shape of the right enterable area FS_R. A specific example of the partitioning using the approximate curve CA will be described later with reference to FIG. 6 and the like.

Here, an example in which the right enterable area FS_R is partitioned into the portion FS_RN belonging to the closer side and the portion FS_RF belonging to the farther side has been described, but similarly, the left enterable area FS_L can also be partitioned into the portion FS_LN belonging to the closer side and the portion FS_LF belonging to the farther side. That is, the above description of the right enterable area FS_R is established as the description of the left enterable area FS_L if the contents thereof are horizontally inverted.

### 5. DERIVATION OF REFERENCE POINT PERFORMED BY REFERENCE POINT DERIVATION UNIT

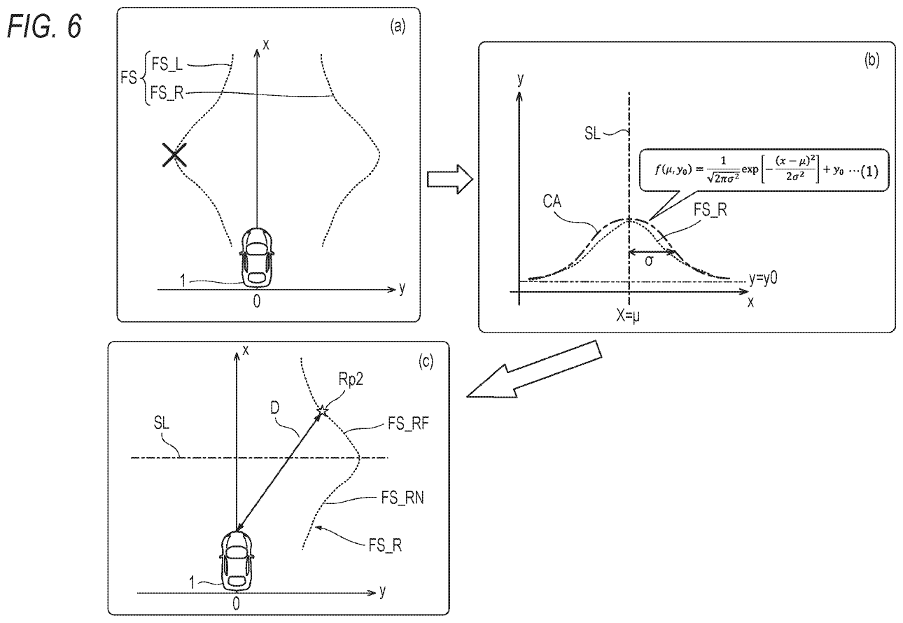

Next, the derivation of the reference point performed by the reference point derivation unit 31c will be described with reference to FIGS. 6 and 7.

Each FS point included in the enterable area FS is represented by, for example, a position (x, y) on xy coordinates with the vehicle 1 as an origin O. Here, the x-axis corresponds to the front-rear direction of the vehicle 1, and the y-axis corresponds to the left-right direction of the vehicle 1 (that is, the vehicle width direction). In the derivation of the reference point, first, the reference point derivation unit 31c specifies the FS point group to be processed this time within the FS point group included in the enterable area FS.

### Farther Reference Point

Here, an example of deriving the farther reference point Rp2 will be described. In this case, as illustrated in (a) in FIG. 6, the reference point derivation unit 31c specifies a FS point group satisfying the condition of y≥0 (in other words, present on the right side of the origin O) within the FS point group included in the enterable area FS as the FS point group to be processed this time. Accordingly, it is possible to extract the FS point group of the right enterable area FS_R from the FS point groups included in the enterable area FS by simple processing.

Next, as illustrated in (b) in FIG. 6, the reference point derivation unit 31c rotates the FS point group of the right enterable area FS_R counterclockwise by θ degrees, and then derives an approximate curve CA having a shape of a normal distribution and a separation line SL (x=μ) by fitting the FS point group to the approximate curve CA (so-called “curve fitting”).

In the case of the example described here, θ degrees is an intersection angle between the travel road Rd1 and the right road Rd3, and can be geometrically obtained with reference to, for example, the map information DB 24. The approximate curve CA having a normal distribution shape can be represented by, for example, Equation (1) illustrated in (b) in FIG. 6. In Equation (1), μ is the average value of the approximate curve CA, and σ is the standard deviation. In general, σ in the approximate curve CA takes a value close to W/2 which is the half value of the road width W of the road intersecting the travel road Rd1 (here, the right road Rd3). Therefore, W/2 may be used as σ if, for example, the map information DB 24 includes information indicating the road width W or the like and thus the road width W is known. The separation line SL is derived, for example, as a straight line passing through the average value μ of the approximate curve CA in parallel to the x axis, that is, x=μ.

Next, as illustrated in (c) in FIG. 6, the reference point derivation unit 31c rotates the approximate curve CA and the separation line SL clockwise by θ degrees, and partitions the right enterable area FS_R into the portion FS_RN belonging to the closer side and the portion FS_RF belonging to the farther side with respect to the separation line SL. At this time, the reference point derivation unit 31c partitions a portion on the closer side of the separation line SL in the right enterable area FS_R as the portion FS_RN belonging to the closer side, and partitions a portion on the farther side of the separation line SL as the portion FS_RF belonging to the farther side. Then, the reference point derivation unit 31c derives, as the farther reference point Rp2, an FS point at a position where a distance D to the vehicle 1 is minimum among the FS points included in the FS point group of the partitioned portion FS_RF belonging to the farther side.

In general, the right enterable area FS_R, which is the right outer edge of the enterable area FS, has a shape close to a normal distribution. Therefore, the right enterable area FS_R can be satisfactorily approximated by the approximate curve CA having the shape of the normal distribution. Therefore, by partitioning the right enterable area FS_R into the portion FS_RN belonging to the closer side and the portion FS_RF belonging to the farther side based on the average value position (that is, x=μ) of the approximate curve CA obtained by approximating the right enterable area FS_R with the normal distribution, it is possible to accurately partition the portion FS_RN belonging to the closer side and the portion FS_RF belonging to the farther side.

In addition, since the connection portion Cn2 (see FIG. 2) between the road boundary RB31 and the road boundary RB42, that is, the actual right farther corner of the intersection IS generally has a shape protruding toward the vehicle 1, it is possible to derive the farther reference point Rp2 with high accuracy with respect to the actual right farther corner of the intersection IS by setting, as the farther reference point Rp2, the FS point at the position where the distance D to the vehicle 1 is minimum among the FS points included in the FS point group of the portion FS_RF belonging to the farther side.

Here, derived as the farther reference point Rp2 is the FS point at the position where the distance D to the vehicle 1 is minimum among the FS points included in the FS point group of the portion FS_RF belonging to the farther side, but the present disclosure is not limited thereto. Instead of this, for example, among the FS points included in the FS point group of the portion FS_RF belonging to the farther side, a point closest to the cross point CP2 between the extension line Ml31a of the road division line Ml31 that defines the right road Rd3 and the extension line Ml42a of the road division line Ml42 that defines the opposite road Rd4 may be derived as the farther reference point Rp2. In this way, it is also possible to derive the farther reference point Rp2 with high accuracy with respect to the actual right farther corner of the intersection IS.

In addition, here, an example of deriving the farther reference point Rp2 has been described, but a point corresponding to the left farther corner of the intersection IS (for example, the predetermined point Rp1′ illustrated in FIG. 7) can also be derived by performing the same processing using the left enterable area FS_L. However, in this case, it should be noted that the above-described θ degrees needs to be the intersection angle between the travel road Rd1 and the left road Rd2.

### Closer Reference Point

Next, an example of deriving the closer reference point Rp1 will be described with reference to FIG. 7. In the following description, the same portions as those in the explanation on FIG. 6 will be appropriately omitted or simplified.

If the closer reference point Rp1 is to be derived, as illustrated in FIG. 7, the reference point derivation unit 31c specifies a FS point group satisfying the condition of y<0 (in other words, present on the left side of the origin O) within the FS point group included in the enterable area FS as the FS point group to be subjected to be processed this time. Accordingly, it is possible to extract the FS point group of the left enterable area FS_L from the FS point groups included in the enterable area FS by simple processing.

Next, similarly to the description of FIG. 6, the reference point derivation unit 31c obtains the approximate curve CA and the separation line SL of the left enterable area FS_L, and partitions the left enterable area FS_L into the portion FS_LN belonging to the closer side and the portion FS_LF belonging to the farther side. Then, the reference point derivation unit 31c derives, as a predetermined point Rp1′, an FS point at a position where the distance D to the vehicle 1 is minimum among the FS points included in the FS point group of the partitioned portion FS_LF belonging to the farther side. That is, if the farther reference point Rp2 described above is a point corresponding to the right farther corner of the intersection IS, the predetermined point Rp1′ can also be said as a point corresponding to the left farther corner of the intersection IS.

Next, the reference point derivation unit 31c derives, as the closer reference point Rp1, for example, a symmetric point that is line-symmetric to the predetermined point Rp1′ with respect to the separation line SL used for partitioning the left enterable area FS_L. Accordingly, even if the connection portion Cn1 between the road boundary RB11 and the road boundary RB21 cannot be recognized, it is possible to accurately derive the closer reference point Rp1, which is a point corresponding to the left closer corner of the intersection IS.

Here, derived as the predetermined point Rp1′ is the FS point at the position where the distance D to the vehicle 1 is minimum among the FS points included in the FS point group of the portion FS_LF belonging to the farther side, but the present disclosure is not limited thereto. Instead of this, for example, among the FS points included in the FS point group of the portion FS_LF belonging to the farther side, a point closest to the cross point CP3 between the extension line Ml22a of the road division line Ml22 that defines the left road Rd2 and the extension line Ml41a of the road division line Ml41 that defines the opposite road Rd4 may be derived as the predetermined point Rp1′. In this way, it is also possible to derive the predetermined point Rp1′ with high accuracy with respect to the actual left farther corner of the intersection IS.

Further, here, the symmetric point that is line-symmetric to the predetermined point Rp1′ is derived as the closer reference point Rp1, but the present disclosure is not limited thereto. For example, within the portion FS_LN belonging to the closer side of the left enterable area FS_L, the FS point at the position where the distance from the above-described symmetric point is the smallest may be derived as the closer reference point Rp1.

### 7. EXAMPLE OF PROCESSING PROCEDURE PERFORMED BY CONTROL DEVICE

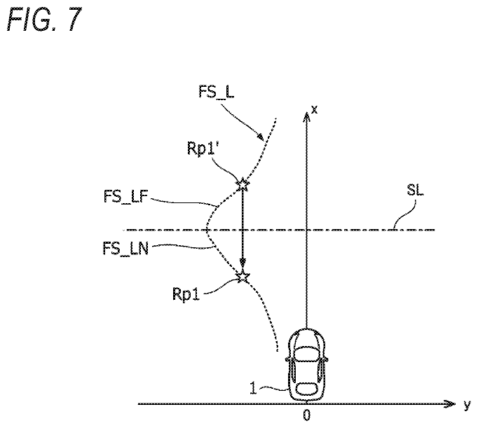

Next, an example of a processing procedure by the control device 30 will be described. FIGS. 8 to 12 are flowcharts (parts 1 to 5) illustrating an example of the processing procedure performed by the control device 30. For example, when an ignition power supply of the vehicle 1 is turned on, the control device 30 executes a series of processing illustrated in FIGS. 8 to 12 at a predetermined cycle.

As illustrated in FIG. 8, first, the control device 30 determines whether an intersection IS is within a predetermined distance (for example, 30 [m]) in the traveling direction of the vehicle 1 (step Sp1). If it is determined that there is such an intersection IS (step Sp1: YES), the control device 30 determines whether the vehicle 1 is to turn right at the intersection IS (step Sp2). If it is determined that the vehicle 1 is to turn right at the intersection IS (step Sp2: YES), the control device 30 executes right-turn processing described later (step Sp3), and ends the series of processing illustrated in FIG. 8.

On the other hand, if it is determined that the vehicle 1 is not to turn right at the intersection IS (step Sp2: NO), the control device 30 determines whether the vehicle 1 is to turn left at the intersection IS (step Sp4). If it is determined that the vehicle 1 is to turn left at the intersection IS (step Sp4: YES), the control device 30 executes left-turn processing described later (step Sp5), and ends the series of processing illustrated in FIG. 8.

If it is determined that the vehicle 1 is not to turn left at the intersection IS, that is, the vehicle 1 is to travel straight at the intersection IS (step Sp4: NO), the control device 30 executes straight travel processing (step Sp6), and ends the series of processing illustrated in FIG. 8. In the straight travel processing in step Sp6, for example, the control device 30 may generate a travel trajectory along which the vehicle 1 travels from the exit of the travel road Rd1 toward the entrance of the opposite road Rd4 without interfering with the center of the intersection IS, and control the steering and the like of the vehicle 1 based on the travel trajectory.

### Right-Turn Processing

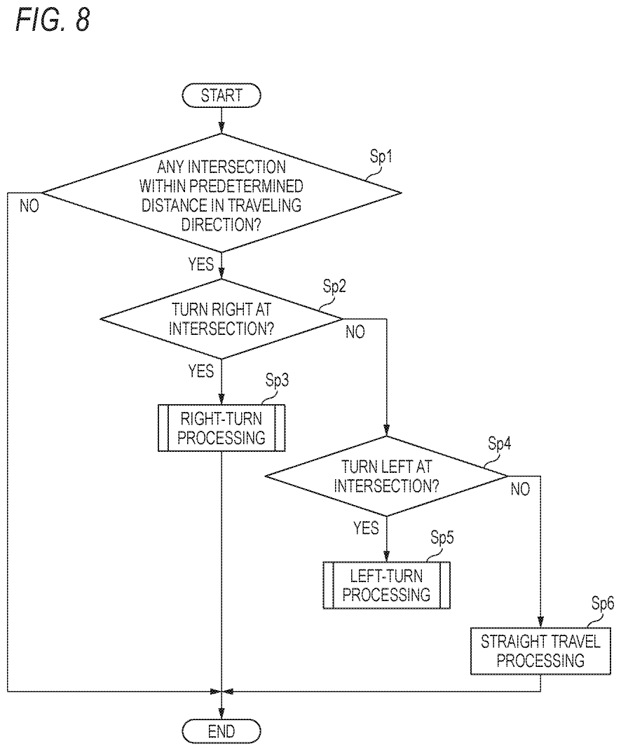

As illustrated in FIG. 9, in the right-turn processing of step Sp3, the control device 30 (for example, the reference point derivation unit 31c) first executes closer reference point derivation of deriving the closer reference point Rp1 (step Sp31), and then executes farther reference point derivation of deriving the farther reference point Rp2 (step Sp32).

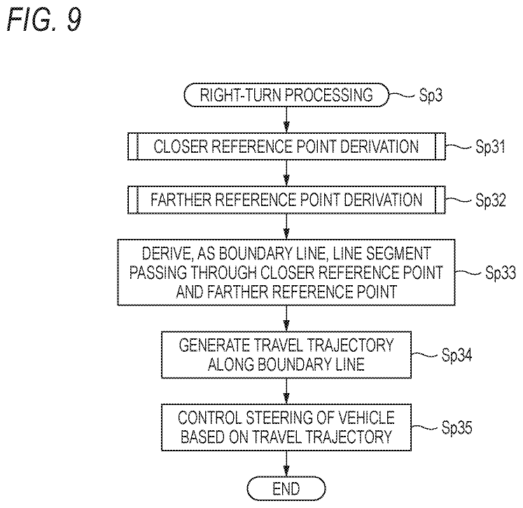

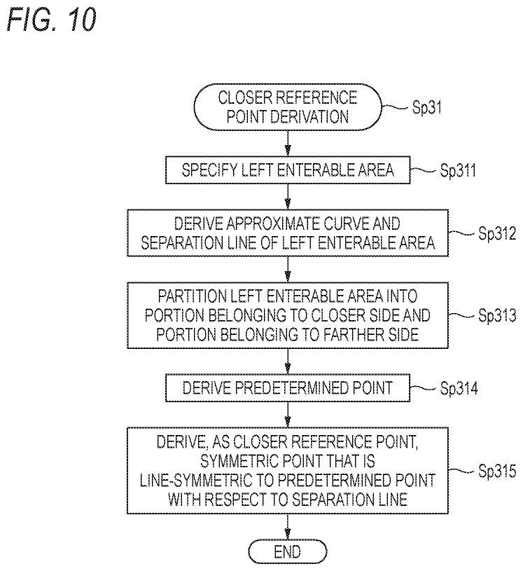

In this way, if both the closer reference point Rp1 and the farther reference point Rp2 are to be derived, the control device 30 derives the closer reference point Rp1 earlier than the farther reference point Rp2, so that it is possible to earlier derive the closer reference point Rp1, which is closer to the vehicle 1 than the farther reference point Rp2 and thus tends to be difficult to recognize. The closer reference point derivation will be described later with reference to FIG. 10, and the farther reference point derivation will be described later with reference to FIG. 11.

Next, the control device 30 derives a line segment passing through the closer reference point Rp1 derived by the closer reference point derivation of step Sp31 and the farther reference point Rp2 derived by the farther reference point derivation of step Sp32 as the boundary line Bd (step Sp33). The boundary line Bd can be obtained geometrically, for example.

Then, the control device 30 generates a travel trajectory Ob1 along the boundary line Bd derived by the processing of step Sp33 (step Sp34), controls steering and the like of the vehicle 1 based on the travel trajectory Ob1 (step Sp35), and ends the current right-turn processing.

### Closer Reference Point Derivation

As illustrated in FIG. 10, in the closer reference point derivation in step Sp31, the control device 30 first specifies the left enterable area FS_L as the FS point group to be processed this time (step Sp311). Then, the control device 30 derives the approximate curve CA and the separation line SL of the left enterable area FS_L (step Sp312).

Next, the control device 30 partitions the left enterable area FS_L into the portion FS_LN belonging to the closer side and the portion FS_LF belonging to the farther side based on the separation line SL derived by the processing of step Sp312 (step S313).

Then, the control device 30 derives, as the predetermined point Rp1′, a point at which the distance D to the vehicle 1 is minimum in the FS point group of the portion FS_LF belonging to the farther side (step Sp314). Then, the control device 30 derives, as the closer reference point Rp1, a target point that is line-symmetric to the predetermined point Rp1′ with respect to the separation line SL (step Sp315), and ends the closer reference point derivation if this time.

### Farther Reference Point Derivation

As illustrated in FIG. 11, in the farther reference point derivation of step Sp32, the control device 30 first specifies the right enterable area FS_R as the FS point group to be processed this time (step Sp321). Then, the control device 30 derives the approximate curve CA and the separation line SL of the right enterable area FS_R (step Sp322).

Next, the control device 30 partitions the right enterable area FS_R into the portion FS_RN belonging to the closer side and the portion FS_RF belonging to the farther side based on the separation line SL derived by the processing of step Sp322 (step S323).

Then, the control device 30 derives, as the farther reference point Rp2, a point at which the distance D to the vehicle 1 is minimum in the FS point group of the portion FS_RF belonging to the farther side (step S324), and ends the farther reference point derivation of this time.

### Left-Turn Processing

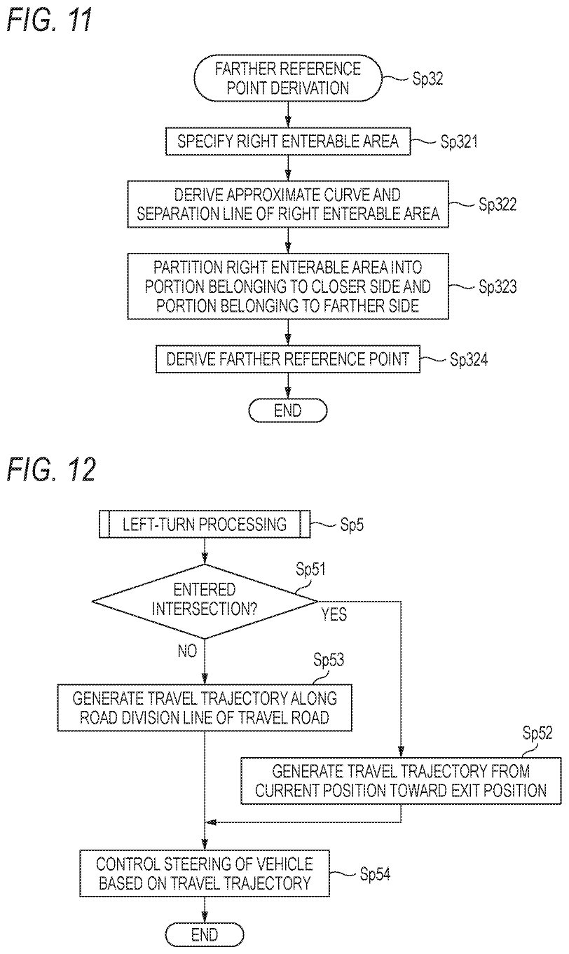

As illustrated in FIG. 12, in the left-turn processing of step Sp5, the control device 30 first determines whether the vehicle 1 has entered the intersection IS (step Sp51). If it is determined that the vehicle 1 has entered the intersection IS (step Sp51: YES), the control device 30 generates the travel trajectory Ob2 from the current position of the vehicle 1 toward the exit position PE (step Sp52), and proceeds to the processing of step Sp54.

On the other hand, if it is determined that the vehicle 1 has not entered the intersection IS (step Sp51: NO), the control device 30 generates the travel trajectory Ob2 along the road division line Ml11 on the left side of the travel road Rd1 on which the vehicle 1 currently travels (step Sp53), and proceeds to the processing of step Sp54.

Next, the control device 30 controls the steering and the like of the vehicle 1 based on the travel trajectory Ob2 generated by the processing of step Sp52 or step Sp53 (step Sp54), and ends the current left-turn processing.

As described above, according to the control device 30 of the present embodiment, if the vehicle 1 is to turn right at the intersection IS, the enterable area FS can be recognized based on the external information detected by the external environment sensor 11, and the closer reference point Rp1 and the farther reference point Rp2 can be accurately derived based on the enterable area FS. By generating the travel trajectory Ob1 along the boundary line Bd passing through the closer reference point Rp1 and the farther reference point Rp2, the steering of the vehicle 1 can be controlled based on the travel trajectory Ob1. As a result, even if no information on the intersection IS is prepared in advance, it is possible to cause the vehicle 1, which is about to turn right at the intersection IS, to travel and turn right at the intersection IS based on the appropriate travel trajectory Ob1 without turning too sharply or too gently at the intersection IS.

Further, according to the control device 30, if the vehicle 1 is to turn left at the intersection IS, it is possible to generate the travel trajectory Ob2 along the road division line Ml11 of the travel road Rd1 on which the vehicle 1 currently travels or the travel trajectory Ob2 from the current position of the vehicle 1 toward the exit position PE based on the external information detected by the external environment sensor 11, and to control the steering of the vehicle 1 based on the generated travel trajectory Ob2. As a result, even if no information on the intersection IS is prepared in advance, it is possible to cause the vehicle 1, which is about to turn left at the intersection IS, to travel and turn left at the intersection IS based on the appropriate travel trajectory Ob2 without turning too sharply or too gently at the intersection IS.

In the example described here, if the farther reference point Rp2 is to be derived, the control device 30 (for example, the reference point derivation unit 31c) derives, as the farther reference point Rp2, the FS point at which the distance D to the vehicle 1 is minimum within the FS point group of the portion FS_RF belonging to the farther side of the separation line SL (step Sp323), but the present disclosure is not limited thereto.

For example, the control device 30 may derive, as the farther reference point Rp2, a point closest to the cross point CP2 between the extension lines Ml31a and Ml42a of the road division line Ml31 that defines the right road Rd3 (that is, the third road) and the road division line Ml42 that defines the opposite road Rd4 (that is, the fourth road). Also in this case, similarly to the above-described example, the farther reference point Rp2 corresponding to the right farther corner of the intersection IS can be obtained accurately.

Similarly, the control device 30 may derive, as the predetermined point Rp1′, the point closest to the cross point CP3 between the extension lines Ml22a and Ml41a of the road division line Ml22 that defines the left road Rd2 (that is, the second road) and the road division line Ml41 that defines the opposite road Rd4, and may derive, as the closer reference point Rp1, the target point that is line-symmetric to the predetermined point Rp1′ with respect to the separation line SL. Also in this case, similarly to the above-described example, the closer reference point Rp1 corresponding to the left closer corner of the intersection IS can be obtained accurately.

### 8. MODIFICATIONS

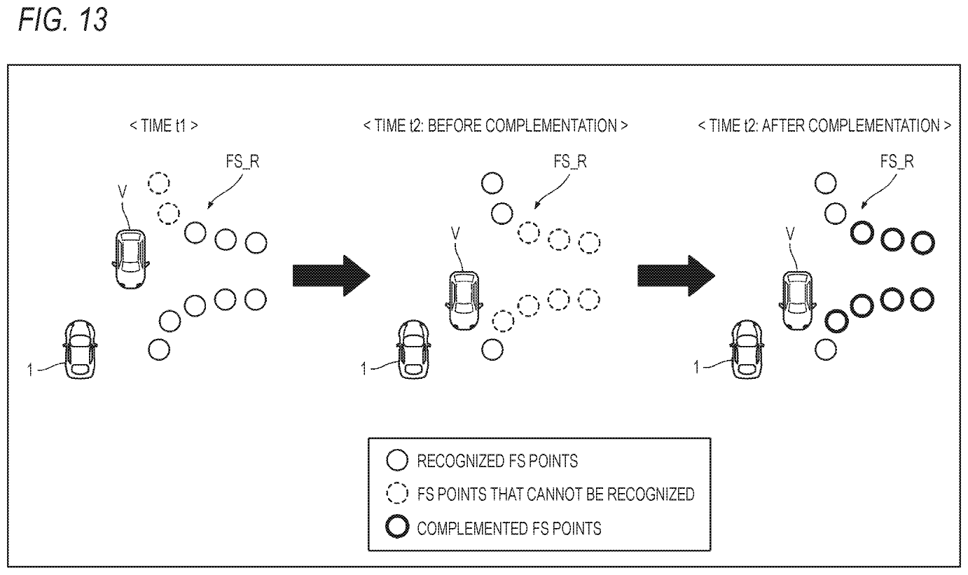

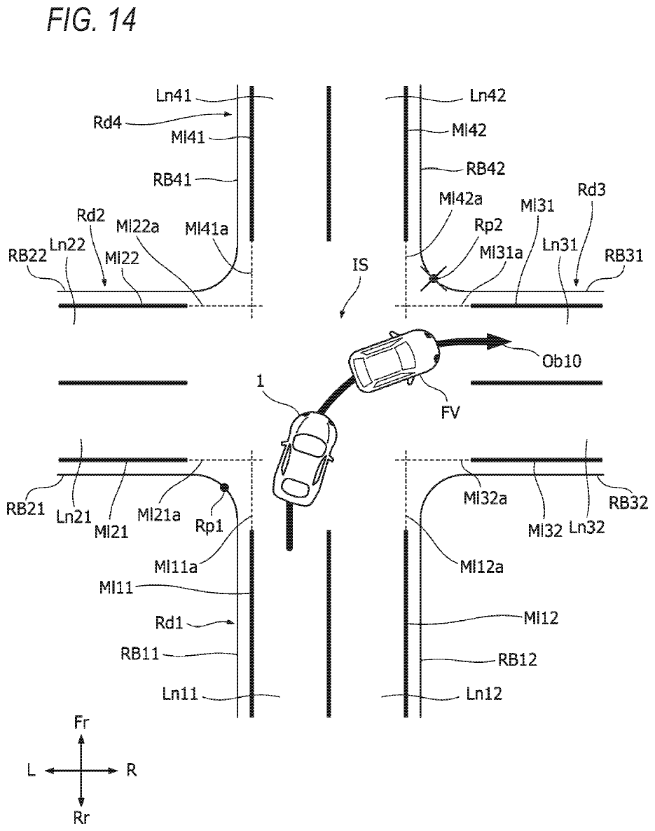

Next, a modification of the processing performed by the control device 30 will be described with reference to FIGS. 13 and 14. Hereinafter, an example in which the vehicle 1 is to turn right at the intersection IS will be mainly described, but the present disclosure is not limited thereto. That is, the same processing may be performed if the vehicle 1 is to turn left or travel straight at the intersection IS.

As described above, if the vehicle 1 is to turn right at the intersection IS, the control device 30 recognizes the enterable area FS based on the external information acquired by the external environment sensor 11, and derives the farther reference point Rp2 from the FS point group of the right enterable area FS_R of the enterable area FS.

However, for example, a situation may occur in which some FS points included in the right enterable area FS_R cannot be recognized well for some reason, such as a place behind the oncoming vehicle traveling in the opposite lane (for example, the lane Ln12 illustrated in FIG. 2) of the current lane (for example, the lane Ln11 illustrated in FIG. 2) in which the vehicle 1 travels.

### First Modification

FIG. 13 illustrates an example of the case where the control device 30 cannot recognize some FS points included in the right enterable area FS_R. In the case of the example illustrated in FIG. 13, at a time t1, since the FS points indicated by broken line circles among the FS points included in the right enterable area FS_R are behind the oncoming vehicle V, the control device 30 cannot recognize the FS points. At a time t2 after the time t1, since the oncoming vehicle V has further traveled toward the vehicle 1 as compared with the time t1, the FS points behind the oncoming vehicle V, that is, the FS points that cannot be recognized by the control device 30 are changed from the time t1.

In such a case, as indicated by “time t2: after complemented” in FIG. 13, the control device 30 may complement the right enterable area FS_R based on the external information acquired at the time t2 with the right enterable area FS_R based on the external information acquired at the time t1 (see the FS points indicated by thick solid line circles). That is, the control device 30 (for example, the enterable area recognition unit 31b) may complement the enterable area FS based on the external information acquired at one timing with the enterable area FS based on the external information acquired at another timing. In this way, even if the oncoming vehicle V or the like is present, it is possible to increase the possibility that the enterable area FS (for example, the right enterable area FS_R) can be recognized appropriately.

### Second Modification

For example, it is assumed that, similarly to the vehicle 1, a preceding vehicle traveling immediately in front of the vehicle 1 is also about to turn right at the intersection IS. In such a case, most of the FS points included in the right enterable area FS_R are behind the preceding vehicle, the control device 30 cannot well recognize the right enterable area FS_R. This may cause a situation in which the farther reference point Rp2 cannot be derived.

FIG. 14 illustrates an example of a case where the control device 30 cannot derive the farther reference point Rp2. In the example illustrated in FIG. 14, similarly to the vehicle 1, a preceding vehicle FV traveling immediately in front of the vehicle 1 is also about to turn right at the intersection IS. In such a case, most of the FS points included in the right enterable area FS_R are behind the preceding vehicle FV. This may cause a situation in which the control device 30 cannot derive the farther reference point Rp2.

In such a case, the control device 30 (for example, the travel control unit 33) may control the travel of the vehicle 1 such that the vehicle 1 travels from the travel road Rd1 toward the right road Rd3 using a travel trajectory Ob10 of the preceding vehicle FV. More specifically, the control device 30 may control the steering and the like of the vehicle 1 such that the vehicle 1 travels from the travel road Rd1 toward the right road Rd3 while tracing the travel trajectory Ob10 of the preceding vehicle FV. In this way, even if the farther reference point Rp2 cannot be derived for some reason, it is possible to cause the vehicle 1 to travel from the travel road Rd1 toward the right road Rd3 on the appropriate travel trajectory Ob10 similar to that of the preceding vehicle FV.

As described above, according to the present embodiment, it is possible to accurately obtain a point corresponding to a corner of an intersection without using high-accuracy map information. In addition, it is possible to improve traffic safety and contribute to the development of the sustainable transportation system.

A road recognition method described in the present embodiment can be implemented by a computer executing a program prepared in advance. For example, the present program is stored in a computer-readable non-transitory storage medium and executed by being read from the storage medium. In addition, the present program may be provided in a form of being stored in a nonvolatile (non-transitory) storage medium such as a flash memory, or may be provided via a network such as the Internet.

Although an embodiment of the present disclosure has been described above, it goes without saying that the present disclosure is not limited to the embodiment. It is apparent that those skilled in the art can conceive of various modifications and alterations within the scope described in the claims, and it is understood that such modifications and alterations naturally fall within the technical scope of the present disclosure.

For example, in the above-described embodiment, if the vehicle 1 is to turn right at the intersection IS, the reference point derivation unit 31c derives both the closer reference point Rp1 and the farther reference point Rp2, but the present disclosure is not limited thereto. For example, if the vehicle 1 is to turn right at the intersection IS, the reference point derivation unit 31c may derive only one reference point between the closer reference point Rp1 and the farther reference point Rp2. In this case, instead of the boundary line Bd described above, the trajectory generation unit 32 may derive a line segment passing through the reference point derived by the reference point derivation unit 31c and the center of the intersection IS or the cross point CP1 or the cross point CP2, and generate a travel trajectory along the line segment.

In the present description and the like, at least the following matters are described. Although corresponding constituent elements and the like in the above embodiment are shown in parentheses, the present disclosure is not limited thereto.
(1) A road recognition device including processing circuitry (road recognition unit 31a, enterable area recognition unit 31b, reference point derivation unit 31c) configured to:
perform road recognition to recognize, at an intersection (intersection IS) present in front of a vehicle (vehicle 1), a second road (left road Rd2) present on one side in a vehicle width direction with respect to a first road (travel road Rd1) on which the vehicle is currently traveling and a third road (right road Rd3) extending on a side opposite to the second road across the intersection;
perform enterable area recognition to recognize an enterable area (enterable area FS) present around the vehicle; and
derive a predetermined reference point (closer reference point Rp1, farther reference point Rp2) based on a result of the road recognition and a result of the enterable area recognition, in which
the processing circuitry is configured to derive, as the reference point, at least one of
   a closer reference point (closer reference point Rp1) of the second road based on a second-road-side enterable area (left enterable area FS_L) present in the enterable area on a side closer to the second road with respect to the first road, and
   a farther reference point (farther reference point Rp2) of the third road based on a third-road-side enterable area (right enterable area FS_R) present in the enterable area on a side closer to the third road with respect to the first road,
      in a case where the closer reference point is to be derived and in a case where the second-road-side enterable area is continuous in a width direction of the second road, the processing circuitry is configured to perform a partition process by partitioning the second-road-side enterable area into a portion (portion FS_LN belonging to closer side) belonging to a closer side and a portion (portion FS_LF belonging to farther side) belonging to a farther side when viewed from the vehicle, and derives the closer reference point based on the portion belonging to the closer side partitioned by the partition process, and
      in a case where the farther reference point is to be derived and in case where the third-road-side enterable area is continuous in a width direction of the third road, the processing circuitry is configured to perform the partition process by partitioning the third-road-side enterable area into a portion (portion FS_RN belonging to closer side) belonging to a closer side and a portion (portion FS_RF belonging to farther side) belonging to a farther side when viewed from the vehicle, and derives the farther reference point based on the portion belonging to the farther side partitioned by the partition process.

According to (1), if the closer reference point is to be derived, the second-road-side enterable area can be partitioned into the portion belonging to the closer side and the portion belonging to the farther side, and the closer reference point can be derived based on the partitioned portion belonging to the closer side. As a result, even if the second-road-side enterable area that is continuous in the width direction of the second road is recognized, it is possible to derive the closer reference point with high accuracy with respect to the corner of the actual intersection. Further, according to (1), if the farther reference point is to be derived, the third-road-side enterable area can be partitioned into the portion belonging to the closer side and the portion belonging to the farther side, and the farther reference point can be derived based on the partitioned portion belonging to the farther side. As a result, even if the third-road-side enterable area that is continuous in the width direction of the third road is recognized, it is possible to derive the farther reference point with high accuracy with respect to the corner of the actual intersection. Therefore, according to (1), it is possible to accurately obtain a point corresponding to a corner of an intersection without using high-accuracy map information.
(2) The road recognition device according to (1), in which
the enterable area is represented by a point group, and
the second-road-side enterable area or the third-road-side enterable area being continuous in the width direction of the second road or the third road respectively means that points representing the enterable area continuously exist in the width direction of the second road or the third road.

According to (2), even if the points representing the second-road-side enterable area or the third-road-side enterable area continuously exist in the width direction of the road, the enterable area can be partitioned into the portion belonging to the closer side and the portion belonging to the farther side.
(3) The road recognition device according to (2), in which
in a case where the second-road-side enterable area or the third-road-side enterable area has a shape like a mountain, the processing circuitry is configured to partition the second-road-side enterable area or the third-road-side enterable area into the portion belonging to the closer side and the portion belonging to the farther side based on a top position of the mountain represented by the enterable area.

According to (3), if the second-road-side enterable area or the third-road-side enterable area has a mountain-like shape, the enterable area can be partitioned into the portion belonging to the closer side and the portion belonging to the farther side by simple processing.
(4) The road recognition device according to (2), in which
the processing circuitry is configured to perform fitting on the second-road-side enterable area or the third-road-side enterable area using a virtual line (approximate curve CA) having a predetermined shape, and partitions the second-road-side enterable area or the third-road-side enterable area into the portion belonging to the closer side and the portion belonging to the farther side based on the virtual line after the fitting.

According to (4), regardless of the shape of the second-road-side enterable area or the third-road-side enterable area, the enterable area can be partitioned into the portion belonging to the closer side and the portion belonging to the farther side.
(5) The road recognition device according to (4), which
the virtual line has a shape of a normal distribution, and
the processing circuitry is configured to partition the normal distribution into the portion belonging to the closer side and the portion belonging to the farther side based on an average value position of the normal distribution after the fitting.

In general, the second-road-side enterable area and the third-road-side enterable area have shapes close to a normal distribution. According to (5), by performing fitting using a virtual line having a shape of a normal distribution and partitioning the normal distribution into the portion belonging to the closer side and the portion belonging to the farther side based on the average value position of the normal distribution after fitting, it is possible to accurately partition the portion belonging to the closer side and the portion belonging to the farther side.
(6) The road recognition device according to (1) or (2), in which
the processing circuitry is configured to
   recognize the enterable area based on external information acquired by an external environment sensor (external environment sensor 11) provided on the vehicle, and
      complement an enterable area that is based on external information acquired at a certain timing with an enterable area that is based on external information acquired at a different timing.

For example, due to the presence of an oncoming vehicle or the like, the enterable area may not be sufficiently recognized in the external information acquired at one timing. According to (6), by complementing the enterable area based on the external information acquired at one timing with the enterable area based on the external information acquired at another timing, even if an oncoming vehicle or the like is present, it is possible to increase the possibility that the enterable area can be recognized appropriately.
(7) The road recognition device according to (2), in which
in a case where the farther reference point is to be derived, the processing circuitry is configured to derive, as the farther reference point, a point closest to the vehicle or a point closest to an intersection (cross point CP2) of extension lines (extension lines Ml31a, Ml42a) of a road division line (road division line Ml31) that defines the third road and of a road division line (road division line Ml42) that defines a fourth road (opposite road Rd4) in the portion belonging to the farther side of the third-road-side enterable area, and
the fourth road is a road extending on a side opposite to the first road across the intersection.

According to (7), it is possible to derive the farther reference point with high accuracy with respect to the corner of the actual intersection by deriving, as the farther reference point, the point closest to the vehicle or the point closest to the intersection of the extension lines of the road division line that defines the third road and the extension line of the road division line that defines the fourth road in the portion belonging to the farther side of the third-road-side enterable area.
(8) The road recognition device according to (2), in which
in a case where the closer reference point is to be derived, the processing circuitry is configured to
   derive a point closest to the vehicle or a predetermined point closest to an intersection (cross point CP3) of extension lines (extension lines Ml41a, Ml22a) of a road division line (road division line Ml22) that defines the second road and an extension line of a road division line (road division line Ml41) that defines a fourth road in the portion belonging to the farther side of the second-road-side enterable area, and
   derive the closer reference point based on a symmetric point that is line-symmetric to the predetermined point with respect to a separation line (separation line SL) partitioning the second-road-side enterable area into the portion belonging to the closer side and the portion belonging to the farther side, and
the fourth road is a road extending on a side opposite to the first road across the intersection.

According to (8), it is possible to derive the closer reference point with high accuracy with respect to the corner of the actual intersection by deriving the closer reference point based on the point closest to the vehicle or the symmetric point that is line-symmetric to the predetermined point closest to the intersection of the extension lines of the road division line that defines the second road and the road division line that defines the fourth road in the portion belonging to the farther side of the second-road-side enterable area.
(9) The road recognition device according to (1), in which
in a case where both the closer reference point and the farther reference point are to be derived, the processing circuitry is configured to derive the closer reference point before the farther reference point.

According to (9), the closer reference point can be derived earlier than the farther reference point, so that it is possible to derive the closer reference point earlier.
(10) The road recognition device according to (1), in which
the processing circuitry (travel control unit 33) is configured to control travel of the vehicle such that the vehicle travels from the first road toward the third road, in which
in a case where the vehicle is to travel from the first road toward the third road and in case where the farther reference point cannot be derived, the processing circuitry is configured to control the travel of the vehicle such that the vehicle travels from the first road toward the third road using a travel trajectory (travel trajectory Ob10) of a preceding vehicle traveling in front of the vehicle from the first road toward the third road.

According to (10), even if the farther reference point cannot be derived for some reason, it is possible to cause the vehicle to travel from the first road toward the third road on the appropriate travel trajectory similar to that of the preceding vehicle.
(11) The road recognition device according to (10), in which
in a case where the vehicle is to travel from the first road toward the third road and in case where the closer reference point and the farther reference point can be derived, the processing circuitry is configured to control travel of the vehicle such that the vehicle travels from the first road toward the third road along a line segment (boundary line Bd) connecting the closer reference point and the farther reference point.

According to (11), if the reference point derivation unit can derive the closer reference point and the farther reference point, it is possible to cause the vehicle to travel from the first road toward the third road on the appropriate travel trajectory in consideration of an oncoming vehicle without requiring high-accuracy map information.

What is claimed is:

1. A road recognition device comprising processing circuitry configured to:
perform road recognition to recognize, at an intersection present in front of a vehicle, a second road present on one side in a vehicle width direction with respect to a first road on which the vehicle is currently traveling and a third road extending on a side opposite to the second road across the intersection;
perform enterable area recognition to recognize an enterable area present around the vehicle; and
derive a predetermined reference point based on a result of the road recognition and a result of the enterable area recognition, wherein
the processing circuitry is configured to derive, as the reference point, at least one of
a closer reference point of the second road based on a second-road-side enterable area present in the enterable area on a side closer to the second road with respect to the first road, and
a farther reference point of the third road based on a third-road-side enterable area present in the enterable area on a side closer to the third road with respect to the first road,
in a case where the closer reference point is to be derived and in a case where the second-road-side enterable area is continuous in a width direction of the second road, the processing circuitry is configured to perform a partition process by partitioning the second-road-side enterable area into a portion belonging to a closer side and a portion belonging to a farther side when viewed from the vehicle, and derives the closer reference point based on the portion belonging to the closer side partitioned by the partition process, and
in a case where the farther reference point is to be derived and in case where the third-road-side enterable area is continuous in a width direction of the third road, the processing circuitry is configured to perform the partition process by partitioning the third-road-side enterable area into a portion belonging to a closer side and a portion belonging to a farther side when viewed from the vehicle, and derives the farther reference point based on the portion belonging to the farther side partitioned by the partition process.

2. The road recognition device according to claim 1, wherein
the enterable area is represented by a point group, and
the second-road-side enterable area or the third-road-side enterable area being continuous in the width direction of the second road or the third road respectively means that points representing the enterable area continuously exist in the width direction of the second road or the third road.

3. The road recognition device according to claim 2, wherein
in a case where the second-road-side enterable area or the third-road-side enterable area has a shape like a mountain, the processing circuitry is configured to partition the second-road-side enterable area or the third-road-side enterable area into the portion belonging to the closer side and the portion belonging to the farther side based on a top position of the mountain represented by the enterable area.

4. The road recognition device according to claim 2, wherein
the processing circuitry is configured to perform fitting on the second-road-side enterable area or the third-road-side enterable area using a virtual line having a predetermined shape, and partitions the second-road-side enterable area or the third-road-side enterable area into the portion belonging to the closer side and the portion belonging to the farther side based on the virtual line after the fitting.

5. The road recognition device according to claim 4, wherein
the virtual line has a shape of a normal distribution, and
the processing circuitry is configured to partition the normal distribution into the portion belonging to the closer side and the portion belonging to the farther side based on an average value position of the normal distribution after the fitting.

6. The road recognition device according to claim 1, wherein
the processing circuitry is configured to
recognize the enterable area based on external information acquired by an external environment sensor provided on the vehicle, and
complement an enterable area that is based on external information acquired at a certain timing with an enterable area that is based on external information acquired at a different timing.

7. The road recognition device according to claim 2, wherein
in a case where the farther reference point is to be derived, the processing circuitry is configured to derive, as the farther reference point, a point closest to the vehicle or a point closest to an intersection of extension lines of a road division line that defines the third road and of a road division line that defines a fourth road in the portion belonging to the farther side of the third-road-side enterable area, and
the fourth road is a road extending on a side opposite to the first road across the intersection.

8. The road recognition device according to claim 2, wherein
in a case where the closer reference point is to be derived, the processing circuitry is configured to
derive a point closest to the vehicle or a predetermined point closest to an intersection of extension lines of a road division line that defines the second road and an extension line of a road division line that defines a fourth road in the portion belonging to the farther side of the second-road-side enterable area, and
derive the closer reference point based on a symmetric point that is line-symmetric to the predetermined point with respect to a separation line partitioning the second-road-side enterable area into the portion belonging to the closer side and the portion belonging to the farther side, and
the fourth road is a road extending on a side opposite to the first road across the intersection.

9. The road recognition device according to claim 1, wherein
in a case where both the closer reference point and the farther reference point are to be derived, the processing circuitry is configured to derive the closer reference point before the farther reference point.

10. The road recognition device according to claim 1, wherein
the processing circuitry is configured to control travel of the vehicle such that the vehicle travels from the first road toward the third road, wherein
in a case where the vehicle is to travel from the first road toward the third road and in case where the farther reference point cannot be derived, the processing circuitry is configured to control the travel of the vehicle such that the vehicle travels from the first road toward the third road using a travel trajectory of a preceding vehicle traveling in front of the vehicle from the first road toward the third road.

11. The road recognition device according to claim 10, wherein
in a case where the vehicle is to travel from the first road toward the third road and in case where the closer reference point and the farther reference point can be derived, the processing circuitry is configured to control travel of the vehicle such that the vehicle travels from the first road toward the third road along a line segment connecting the closer reference point and the farther reference point.
